(19) United States
(12) Patent Application Publication
(10) Pub. No.: US 2011/0134086 A1
(43) Pub. Date: Jun. 9, 2011

(54) DISPLAY METHOD FOR E-PAPER APPARATUS

(76) Inventors: Cheng-Hsin Chang, Taipei (TW); Yu-Sheng Chen, Taipei (TW)

(21) Appl. No.: 12/630,146

(22) Filed: Dec. 3, 2009

(51) Int. Cl. G09G 5/00

(52) U.S. Cl. 345/204

(57) ABSTRACT

The present invention provides a display method for an e-paper apparatus. The display method is applied to the e-paper apparatus having a memory unit, a control unit, an e-paper driver unit and an e-paper unit. The display method comprises steps as follows. The control unit controls the e-paper driver unit to update all pixels in a picture frame of the e-paper unit to a predetermined gray scale when the displayed picture frame of the e-paper unit is to be changed. The control unit looks up a waveform table in the memory unit according to the updated picture frame, and it controls the e-paper driver unit to generate the required waveform and drive the e-paper unit.

### BACKGROUND OF THE INVENTION

1. Field of the Invention

The present invention relates to a display method and in particular to a display method for an e-paper apparatus.

2. Description of Conventional Art

E-paper has the following advantages. It is flexible and consumes power only when there is a change to the display content. Thus, e-paper display is power-saving, with no view angle problem (no dead corners in vision), and the content displayed on e-paper can be seen clearly even under the sunlight. The e-paper is a new-generation display technology, and all the advanced nations in the world are gradually investing a lot of time and money in researching and manufacturing of e-paper display. Such a revolutionary display technology will bring a substantial change to our life, and thus it has a good prospect.

According to the control means, the current e-paper can be classified into two categories: matrix type and direct type. If unspecific (changeable) characters or patterns are to be displayed, it is necessary to use the matrix-type e-paper. The matrix-type e-paper comprises a power controller chip, a timing controller chip, a DC conversion chip, and a plurality of gate drivers and source drivers on a printed circuit board.

Please refer to FIG. 1, which is a block view of an e-paper apparatus. The e-paper apparatus comprises a memory unit 10, a control unit 20, an e-paper driver unit 30, and an e-paper unit 40. The control unit 20 is electrically connected to the memory unit 10 and the e-paper driver unit 30. The e-paper unit 40 is electrically connected to the e-paper driver unit 30.

In conventional art, when a picture frame of the e-paper unit 40 needs to be updated, the control unit 20 will compare the old picture frame with a new picture frame to look up a waveform table (not shown) stored in the memory unit 10, thereby controlling the e-paper driver unit 30 to output the required waveforms to the e-paper unit 40. In this way, the new picture frame can be obtained.

For example, for a 16-level gray scale display, each pixel in the old picture frame has 16 possible levels, and the pixel in the new picture frame also has 16 possible levels, so that there are 16×16=256 waveform combinations to change the gray scale in the old picture frame to the new picture frame for every pixel. Thus, the memory unit 10 needs to store driving waveforms corresponding to the aforesaid 16×16=256 waveform combinations in the waveform table, which will be looked up by the control unit 20. As a result, the memory unit 10 needs a great amount of capacity. Further, since the old picture frame is compared with the new picture frame, the memory unit 10 actually comprises two frame buffers, one for storing the old picture frame and the other for storing the new picture frame.

Therefore, according to the abovementioned conventional display method for the e-paper apparatus, the memory unit needs a great amount of capacity, which increases the cost and also makes it difficult to increase the resolution of e-paper.

### SUMMARY OF THE INVENTION

In order to solve the drawbacks in the conventional art, the present invention provides a display method for an e-paper apparatus.

The present invention provides a display method for an e-paper apparatus. The display method is applied to an e-paper apparatus having a memory unit, a control unit, an e-paper driver unit and an e-paper unit. The display method comprises steps as follows. The control unit controls the e-paper driver unit to update all pixels in a picture frame of the e-paper unit to a predetermined gray scale when the displayed picture frame of the e-paper unit is to be changed. The control unit looks up a waveform table in the memory unit according to the updated picture frame, and it controls the e-paper driver unit to generate the required waveform and drive the e-paper unit.

### BRIEF DESCRIPTION OF THE DRAWINGS

FIG. 1 is a block view of an e-paper apparatus; and

FIG. 2 is a flow chart of the display method for an e-paper apparatus according to the present invention.

### DETAILED DESCRIPTION OF THE INVENTION

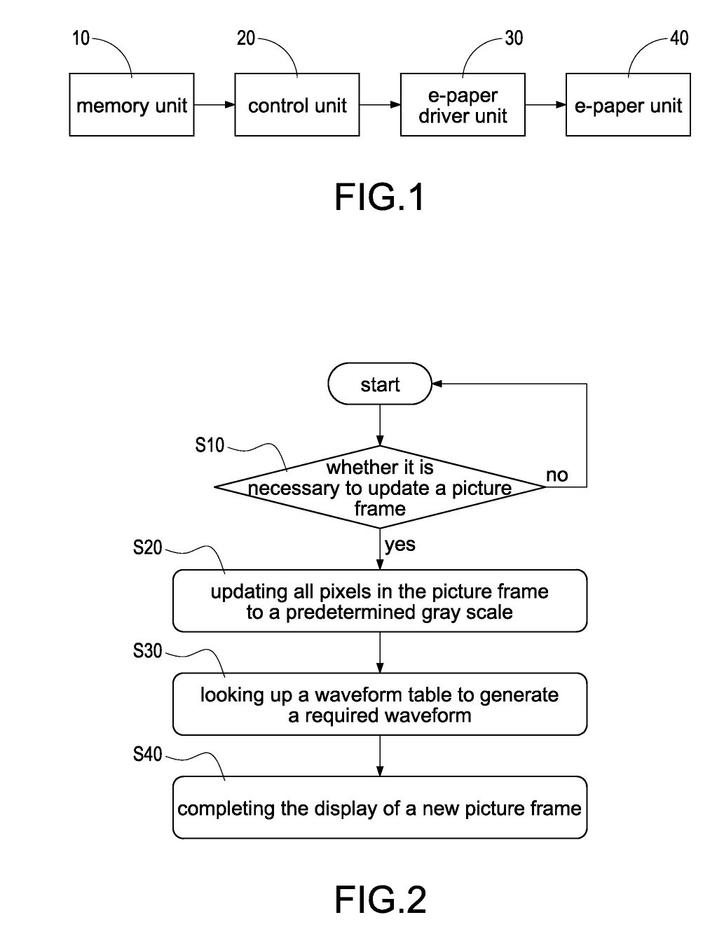

Please refer to FIG. 1, which is the block view of the e-paper apparatus. The display method for an e-paper apparatus according to the present invention can be applied to an e-paper apparatus shown in FIG. 1. The difference between the present invention and the conventional art lies as follows. In the conventional art, when the picture frame is to be updated, the old picture frame is compared with a new picture frame directly. Unlike the conventional art, the display method of the present invention first changes the old picture frame into a predetermined gray scale, and then changes the predetermined gray scale into a new picture frame with updated gray level (the predetermined gray scale may be black or white).

The advantage of the present invention is as follows. In a 16-level gray scale example, the conventional art needs to store the driving waveforms corresponding to 16×16=256 waveform combinations in the waveform table, while the present invention only needs to store the driving waveforms corresponding to 16+16=2*16=32 waveform combinations in the waveform table. The reason for the above difference is as follows. The present invention first changes the old picture frame into a predetermined gray scale. The predetermined gray scale is selected, so that it has only 16 waveform combinations corresponding to each gray scale to change to predetermined gray scale (for 16-level gray scale, only 16 waveform combinations). After the pixels in the old picture frame are changed into the predetermined gray scale, the present invention then changes the predetermined gray scale into the gray scale required by the new picture frame. For predetermined gray scale to change into gray scale required by the new picture frame, another 16 waveform combinations are needed. Therefore, the present invention only needs to store the driving waveforms corresponding to 16+16=2×16=32 waveform combinations in the waveform table. In this way, the capacity of the memory unit 10 can be reduced greatly.

Further, if the predetermined gray scale is selected to be black or white, the capacity of the memory unit 10 can be further reduced because the e-paper driver unit 30 can be controlled by the control unit 20 to force the pixels in the picture frame of the e-paper unit 40 to become black or white. Thus, the step of looking up the waveform table from the old picture frame to the predetermined gray scale can be omitted, so that only the driving waveforms corresponding to 16 waveform combinations from black (or white) to the required gray scale in the new picture frame have to be stored in the waveform table. Of course, the present invention is not limited to the aforesaid special case that the control unit 20 needs not to look up the waveform table when changing into black or white. The present invention may still require the control unit 20 looking up the waveform table in changing the old picture frame into a predetermined gray scale. Thus, as mentioned above, the present invention needs to store the driving waveforms corresponding to 16+16=2×16=32 waveform combinations in the waveform table for a 16 gray scale display. For a N gray scale display, where N=number of gray scale, the present invention only needs to store the driving waveforms corresponding to N+N=2N waveform combinations in the waveform table. Or if the predetermined gray scale is black (or white), the required number of waveform combinations will be N.

Further, since the present invention does not compare the old picture frame with the new picture frame directly, it is unnecessary to have two frame buffers to store the new picture frame and the old picture frame respectively. The present invention only needs one frame buffer.

Please refer to FIG. 2, which is a flow chart of the display method for an e-paper apparatus according to the present invention. First, the control unit 20 determines whether it is necessary to update the picture frame of the e-paper unit 40 (step S10). If it is necessary to update the picture frame of the e-paper unit 40, the control unit 20 will control the e-paper driver unit 30 to update the pixels in the picture frame of the e-paper unit 40 to a predetermined gray scale (step S20). Then, according to the updated picture frame, the control unit 20 looks up the waveform table stored in the memory unit 10, thereby controlling the e-paper driver unit 30 to generate a required waveform and drive the e-paper unit 40 (step S30). Finally, the new picture frame of the e-paper unit 40 can be displayed completely (step S40).

In the step S20, the control unit 20 looks up the waveform table stored in the memory unit 10, thereby controlling the e-paper driver unit 30 to update the pixels in the picture frame of the e-paper unit 40 to the predetermined gray scale. Alternatively, when the predetermined gray scale is black or white, the control unit 20 may control the e-paper driver unit 30 to update the pixels in the picture frame of the e-paper unit 40 to become black or white.

The characteristics of the present invention are as follows. Since the conventional art updates the old picture frame into a new picture frame directly, the capacity of the memory unit in the conventional art for storing the waveform table is much larger due to a lot of possible gray scale waveform combinations. Further, the conventional art needs two frame buffers, one for storing the old picture frame and the other for storing the new picture frame. On the contrary, the present invention changes the old picture frame into a predetermined gray scale (or, black or white), and then changes the predetermined gray scale into a new picture frame. Thus, the capacity of the memory unit can be reduced greatly due to the substantial reduction in the possible gray scale combinations. Further, the number of the picture buffers can be reduced.

According to the above, the present invention really demonstrates industrial applicability, novelty and inventive steps. Further, the construction of the present invention has not been seen in products of the same kind or let in public use, so that the present invention conforms to the requirements for an invention patent.

What is claimed is:

1. A display method for an e-paper apparatus, the method being applied to the e-paper apparatus comprising a memory unit, a control unit, an e-paper driver unit, and an e-paper unit, the method including steps of:
a) the control unit controlling the e-paper driver unit to update all pixels in a picture frame of the e-paper unit to a predetermined gray scale when the displayed picture frame of the e-paper unit is to be changed; and
b) the control unit looking up a waveform table in the memory unit according to the updated picture frame, and controlling the e-paper driver unit to generate a required waveform and drive the e-paper unit.

2. The method according to claim 1, wherein the control unit looks up the waveform table stored in the memory unit to control the e-paper driver unit to update all pixels in the picture frame of the e-paper unit to the predetermined gray scale when the picture frame of the e-paper unit is to be changed in the step a).

3. The method according to claim 1, wherein the predetermined gray scale is white, the control unit looks up the waveform table stored in the memory unit to control the e-paper driver unit to update all pixels in the picture frame of the e-paper unit to become white when the picture frame of the e-paper unit is to be changed in the step a).

4. The method according to claim 1, wherein the predetermined gray scale is white, the control unit controls the e-paper driver unit to update all pixels in the picture frame of the e-paper unit to become white when the picture frame of the e-paper unit is to be changed in the step a).

5. The method according to claim 1, wherein the predetermined gray scale is black, the control unit looks up the waveform table stored in the memory unit to control the e-paper driver unit to update all pixels in the picture frame of the e-paper unit to become black when the picture frame of the e-paper unit is to be changed in the step a).

6. The method according to claim 1, wherein the predetermined gray scale is black, the control unit controls the e-paper driver unit to update all pixels in the picture frame of the e-paper unit to become black when the picture frame of the e-paper unit is to be changed in the step a).
